(19) United States
(12) Patent Application Publication
(10) Pub. No.: US 2013/0108855 A1
(43) Pub. Date: May 2, 2013

(54) Porous Glass Articles Formed Using Cold Work Process

(71) Applicants: Grant Marchelli, Shoreline, WA (US); Renuka Prabhakar, Seattle, WA (US)

(72) Inventors: Grant Marchelli, Shoreline, WA (US); Renuka Prabhakar, Seattle, WA (US)

(21) Appl. No.: 13/695,608

(22) PCT Filed: Jun. 2, 2011
(86) PCT No.: PCT/US11/38954

§ 371 Date: Jan. 11, 2013

Related U.S. Application Data
(60) Provisional application No. 61/350,816, filed on Jun. 2, 2010.

(51) Int. Cl. C03B 19/09; C03C 11/00

(52) U.S. Cl. CPC C03B 19/09; C03C 11/00
USPC 428/221; 65/17.6; 65/22

(57) ABSTRACT

Glass articles and methods for making the articles are provided. The glass articles are comprised of microscopic glass particles bound together to form an interconnected porous network within the articles. The porous interconnected network of fused glass particles provides an apparent porosity to the article, and thereby the ability to deliver water uniformly throughout the glass article via capillary forces.

### CROSS-REFERENCE TO RELATED APPLICATION

This application is claims the benefit of U.S. Provisional Patent Application No. 61/350,816, filed Jun. 2, 2010, the disclosure of which is incorporated herein by reference in its entirety.

### BACKGROUND

In 2008, glass accounted for 12.2 million tons of the total municipal solid waste stream. Only 23% of this post-consumer waste glass was recovered for recycling; the remaining 77% ended up in landfills across the United States. Nearly 90% of the recovered glass is processed for use as a supplement to traditional raw materials in container production, where the recovered glass is combined with raw materials before subsequent processing. This has the effect of reducing the melting temperature of the mix, thereby lowering energy costs associated with furnace operation. However, when the energy consumed over the entire recycling process is taken into consideration, the environmental benefits of glass recycling are not as large as it would seem. The time and energy required for suitably refining the recovered glass are not offset by the energy saved through dilution of the raw material mixture. In fact, dilution of the raw material stream with 10% waste glass reduces overall energy consumption by about 1-3%. In addition, the machinery used in the refining process carries its own manufacturing and repair costs. Considering the large amount of waste glass generated each year, new technologies are required in order to minimize waste, energy consumption and related greenhouse gas emissions.

Traditionally, glass is produced in one of three ways: 1) blowing, which requires the glass to be in a molten state, 2) floating, which requires not only molten glass, but also molten metal, and 3) fusing, which requires glass to reach a semi-molten state. This is accomplished through the use of large furnaces or kilns that require peak firing temperatures between 2000-2800° F. The peak temperature must be achieved through very slow heating rates and maintained to achieve a uniform melt, which can often take up to 30 hours and sometimes longer. While in this molten state, the glass is manipulated to produce the desired shape and then, in many cases, reintroduced into the kiln or furnace, where it can be cooled slowly to prevent fracture.

Recovered post-consumer glass is primarily used in container manufacturing, where it is crushed into “cullet”, and then introduced into the raw material stream, which is typically composed of sand, soda ash, and limestone. The mixture is then heated to its melting point, generally 2600-2800° F., and molded or blown into the desired shapes. The addition of crushed glass has two main environmental benefits. First, it reduces the total amount of raw materials used. Second, the process consumes less energy, as the crushed glass has a lower melting temperature than the raw materials alone. When the melting temperature is lowered, the energy requirements are reduced, which leads to prolonged furnace life and cost savings.

The major drawback to this process is the need for very high quality cullet. High quality cullet must be free of contaminants such as paper, metal, porcelain, and ceramics. For container production, colored glass is also considered a contaminant, as the materials used for coloration have the effect of varying the melting temperature. This means the waste glass collected through municipal programs must he sorted for color by hand before processing. Once this is done, essentially all colored glass is sent to the landfill and the clear glass is run through a series of refining steps employing magnets, air currents and sometimes lasers, to remove the remaining contaminants. This machinery carries a large associated cost, due to its complexity and energy requirements.

Secondary uses of waste glass include fiberglass insulation manufacturing, filters and tile production. Waste glass can account for up to 55% of commercially produced insulation and is mixed with the same raw materials used in container manufacturing. However, the resource is mostly comprised of post-industrial glass, primarily from window manufacturing waste, rather than post-consumer glass. In addition, the first step in the manufacturing process is the formation of glass marbles from a molten combination of raw and waste materials, which requires furnace temperatures in excess of 2000° F.

In tile manufacturing, the percentage of waste glass may account for as much of 99% of the resource stream. However such goods account for a small portion of the total quantity of glass that is currently recycled and, due to the scale of manufacturing facilities, can be quite expensive to produce. Further, the process largely utilizes post-industrial glass and still requires firing the glass to temperatures upwards of 2000° F. Currently, there is no large-scale manufacturing process in place that has the ability to accommodate for contaminants, such as paper, plastic, metal and ceramic, or provide sufficient energy benefit to offset the expense associated with production from 100% post-consumer glass. The former is largely due to the fact that such inclusions would result in non-uniform melt temperatures; the latter is largely due to the high working temperatures related to conventional glass manufacturing technology.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In view of the need for cost and energy-efficient recycling of glass waste, methods are disclosed herein that are compatible with typical post-consumer glass waste for use as a feedstock in a relatively low-temperature process for forming a glass article, such as a brick, tile, or panel. In the methods provided, a powder or slurry of microscopic glass particles (e.g., ground post-consumer glass) is molded and heated according to a specific heating schedule, which has a maximum temperature below the melting temperature of glass. The methods produce a glass article that has useful properties, including the ability to strongly wick liquid throughout the article via capillary forces. Such attributes make the formed articles ideal for applications such living walls and evaporative cooling systems.

In one aspect, a glass article is provided. In one embodiment, the glass article comprises a porous interconnected network of fused glass particles that has an apparent porosity of 1-55% and the ability to deliver water uniformly throughout the glass article via capillary action forces.

In another aspect, a method is provided for forming a glass article comprising a porous interconnected network of fused glass particles that has an apparent porosity of 1-55%. In one embodiment, the method comprises the steps of:
(a) providing a dry precursor in a mold, said dry precursor comprising a glass powder having a particle size of from 0.001-2200 microns;
(b) packing the dry precursor in the mold (e.g., by shaking, vibration, and/or pressing); and
(c) heating the dry precursor in the mold to produce a glass article, wherein heating the dry precursor comprises a first heating schedule that includes at least the sequential steps of:
   (i) heating at a first rate to a first temperature and holding for a first hold time;
   (ii) heating at a second rate to a second temperature and holding for a second hold time, wherein the second temperature is greater than the first temperature;
   (iii) cooling by convection at a third rate to a third temperature and holding for a third hold time, wherein the third temperature is less than the first temperature; and
   (iv) cooling by convection at a fourth rate to a fourth temperature and holding for a fourth hold time, wherein the fourth temperature is less than the third temperature.

In another aspect, a method is provided for forming a glass article comprising a porous interconnected network of fused glass particles that has an apparent porosity of 1-55%. In one embodiment, the method comprises the steps of:
(a) providing a dry precursor in a mold, said dry precursor comprising a glass powder having a particle size of from 0.001-2200 microns;
(b) packing the dry precursor in the mold; and
(c) heating the dry precursor in the mold to produce a glass article, wherein heating the dry precursor comprises a first heating schedule that includes at least the sequential steps of:
   (i) heating at a first rate to a first temperature and holding for a first hold time;
   (ii) heating at a second rate to a second temperature and holding for a second hold time, wherein the second temperature is greater than the first temperature; and
   (iii) cooling by convection at a third rate to a third temperature and holding for a third hold time, wherein the third temperature is less than the first temperature.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a mold useful for forming a glass article according to the embodiments provided herein;

FIG. 2A illustrates a glass article precursor filled in a mold in accordance with the embodiments provided herein;

FIG. 2B is a cross-sectional view across line 2B-2B in FIG. 2A;

FIG. 2C is a photograph of an exemplary embodiment similar to that illustrated in FIG. 2A, wherein the precursor is a wet precursor comprising glass particles, a liquid, and a binder;

FIG. 2D illustrates a glass article formed by heating the precursor illustrated in FIG. 2A;

FIG. 2E is a cross-sectional view across line 2E-2E in FIG. 2D;

FIG. 2F is a photograph of an exemplary glass article formed by heating the precursor pictured in FIG. 2C;

FIG. 3 is a graph illustrating the relationship between peak heating temperature of a precursor and the apparent porosity of a formed glass article in accordance with the embodiments provided herein;

FIG. 4 is a graph illustrating the relationship between peak heating temperature of a precursor and the apparent capillary rate of a formed glass article in accordance with the embodiments provided herein;

FIG. 5 illustrates the time required to saturate an exemplary glass article to a particular percentage saturation;

FIG. 6 graphically illustrates the relationship between apparent porosity and the time required to saturate an exemplary glass article to a particular saturation percentage;

FIGS. 7A-7C illustrate three exemplary mechanisms by which glass particles in a precursor are bound together to form the glass article in accordance with the embodiments provided herein;

FIG. 8 is a flow chart illustrating a “dry” precursor method for forming a glass article in accordance with the embodiments provided herein;

FIG. 9 is a flow chart illustrating a “wet” precursor method for forming a glass article in accordance with the embodiments provided herein;

FIG. 10 illustrates a first representative heating profile in accordance with the embodiments provided herein;

FIG. 11 illustrates a second representative heating profile in accordance with the embodiments provided herein;

FIG. 12 is a diagrammatic illustration of a living wall integrating a glass article, in accordance with the embodiments provided herein;

FIG. 13 is a diagrammatic illustration of an evaporative cooling system incorporating a glass article, in accordance with the embodiments provided herein;

FIG. 14 is a diagram illustrating an exemplary method for recycling waste glass to form a glass article (e.g., a brick), in accordance with the embodiments provided herein, using a “wet” precursor method; and

FIG. 15 is a diagram illustrating an exemplary method for recycling waste glass to form a glass article (e.g., a brick), in accordance with the embodiments provided herein, using a “dry” precursor method.

### DETAILED DESCRIPTION

Glass articles and methods for making the articles are provided. The glass articles are comprised of microscopic glass particles bound together to form an interconnected porous network within the articles.

In one embodiment, the glass article comprises a porous interconnected network of fused glass particles that has an apparent porosity and the ability to deliver water uniformly throughout the glass article via capillary forces.

The article is formed from glass particles (also referred to herein as a glass powder) connected together to form the porous interconnected network. The glass particles are the starting material for making the article. The glass particles can be particles of any type of glass known to those of skill in the art. In certain embodiments, the glass is post-consumer or post-industrial glass. However, virgin or non-recycled glass is also useful for forming the glass articles.

Typically, glass is produced using hot-working processes, which consists of melting the glass in a large furnace or kiln at high temperatures, and then forming the glass in a molten or semi-molten state. One of the novelties of the methods described herein is the ability to form the glass in a “cold” state, also referred to herein as a “cold work” process. In a cold work process, glass is formed from a precursor comprising glass particles in powder form. The precursor is then formed into the desired shape via conventional processes (e.g., press forming, casting, extruding, etc.) at room temperature. By forming the shape of the glass article at room temperature, there is no need to raise the glass to a temperature at which glass is malleable, resulting in large energy savings. While the methods described herein do require heating the precursor to form the glass article, the heating temperatures required are well below the melting temperature of the glass.

The glass article is machinable using standard masonry tooling such as tile saws and drill bits. Machining enables the glass articles to be manipulated following the heating process (e.g., for custom shapes or adding mounting points). Due to their extremely brittle nature and comparatively low strength, typical glass articles, such as tiles, windows, and bottles, are not easily machined; it is possible, but special care must be given to said articles.

Unlike typical glass-recycling technologies, any color of glass can be used to form the articles. Additionally, the methods for forming the articles are significantly more tolerant to contaminants than typical recycling methods. For example, in one embodiment, the article includes up to 10% contaminants, by weight. Such contaminants may include paper, plastic, ceramic, metal, and combinations thereof. The ability to form the articles despite a relatively large contaminant component provides a significant benefit when using post-consumer or post-industrial glass because less rigorous purification of the raw materials is required. In one embodiment, the contaminants have a maximum particles size of 750 microns when incorporated into the article.

The glass particles are provided as a precursor material prior to heating to form the glass article. The glass particles have a size range of from about 1 nanometer to 2.2 millimeters. In a preferred embodiment, the glass particles have a size range of from 1-999 microns. In certain embodiments, the glass particles are provided in the desired size range by pulverizing or otherwise granularizing larger pieces of glass. In certain embodiments, the glass particles are obtained by pulverizing post-consumer or post-industrial (“recycled”) glass. Any contaminants in the precursor can also be pulverized, particularly as part of a glass recycling system to provide the precursor.

The particles are fused or otherwise connected such that the particles still retain some of their original shape. That is, the particles are not melted, or not entirely melted, during production of the article. Accordingly, the voids in between particles prior to heating to produce the article then become the interconnected porous network.

The pores of the article are voids within the article. The pores are both internal and on the exterior surface of the article. The pores on the exterior surface of the article result in a surface that is textured and of a large surface area. The pores on the interior of the article are typically interconnected to form an interconnected network of pores.

In certain embodiments, the apparent porosity of the articles is from 1-55%. In certain embodiments, the apparent porosity is from 3-20%. In certain other embodiments, the apparent porosity is from 40-55%. As will be discussed further below, the greater the apparent porosity, the more quickly the glass article will saturate with moisture. However, larger apparent porosity also decreases the structural integrity of the article. Accordingly, for structural applications, such a bricks or panels, lower apparent porosity is desirable.

As used herein, “apparent porosity” (“P”) expresses, as a percent, the relationship of the volume of the open pores of the article to its exterior volume, as set forth by ASTM International. The apparent porosity only takes into account “open” pores, which are those pores in liquid communication with an exterior surface of the article. The apparent porosity does not account for “closed” pores, which are pores not in liquid communication with an exterior surface of the article.

One method for determining apparent porosity according to the ASTM International definition is as follows: The glass articles are dried to a “dry mass” (“D”) and are weighed. Next, the articles are submerged in a pan of distilled water. The articles are then boiled for a total of 5 hours (in the distilled water), and are allowed to soak in the distilled water for an additional 24 hours, to allow for complete impregnation of the distilled water into the open pores of the articles. Once the articles have reached maximum saturation, they are weighed while suspended in a bath of distilled water. The mass of the articles while suspended in water is the “suspended mass” (“S”). The “saturated mass” (“M”) is then found by weighing the saturated article in air. The exterior volume of the specimen can then be found using: V=(M−S)/ρ_{w}, where V is the exterior volume of the specimen, and M and S are previously defined as saturated mass and suspended mass, respectively, and (“ρ_{w}”) is the “density of the water”. The apparent porosity (as a percentage) can be determined using: P=[(M−D)/V]×100. Accordingly, in certain embodiments, the apparent porosity is determined using the above described formula P=[(M−D)/V]×100.

The porous network results in several characteristics, including the ability to transport a liquid throughout the article by capillary forces. Such properties give rise to several applications for the articles, including use as building materials. As a result of capillary forces, if a glass article is place in contact with a reservoir of liquid (e.g., water), the liquid will be transported throughout the article wherever the interconnected network travels, until the article is saturated with the liquid, assuming sufficient liquid in the reservoir.

In certain embodiments, the glass article has the ability to deliver water uniformly throughout the glass article via capillary forces through the porous interconnected network. In this regard, if the article is placed in contact with water (or another liquid), upon saturation, the amount of water in any given portion of the article will be essentially the same as any other similarly sized portion.

The composition of the glass article is a result of the process by which it is formed. While each glass article comprises a porous network, the size of the pores and the size of the network depend in part on the heating schedule used to fuse the original particles together to form the article, as will be described in more detail below. The size and composition of the original glass particles will also affect the structure of the formed glass article.

There are two primary routes, a “dry” method and a “wet” method, to forming the articles, each of which will be described in more detail below. As the names imply, the wet method includes a liquid mixed with the glass particles. This wet mixture forms a slurry that can be extruded or otherwise molded into the desired shape. The dry method includes only the glass particles or may optionally include a binder compound. The wet method may also include a binder.

After heating, the resulting glass article is essentially the same if formed by the wet or dry method. Both possess the ability to deliver liquid uniformly throughout the glass article and both possess comparable mechanical properties. The presence of water (or another liquid) inside the interconnected pores of the article does not adversely affect the structural integrity of the article; the liquid simply occupies the void space that was previously occupied by air. However, one advantage of using a wet precursor is that it enables the use of extrusion and other molding techniques not possible with a dry precursor.

If the article is formed using a binder in the starting materials, the presence of the binder will affect the mechanical and physical properties of the formed glass article. The binder enables the creation of an interconnected network of micropores. While not wishing to be bound by theory, it is believed that in certain embodiments, the binder is eliminated (e.g., burns off) during heating and leaves an interstitial void in the glass matrix formed by the bound glass particles. The presence of these voids creates the internal network of pores. Residual carbon may also become trapped within the voids. Trapped carbon may obstruct the porous network, causing a reduction in capillary forces for the bulk glass article. The residue of the burned off binder may also interact with the glass at the microstructural level, resulting in a glass article exhibiting superior strength when compared to an article formed without use of the binder.

The binder provides a mechanism by which the glass particles are held adjacent to one another prior to heating to form the article. In this regard, the glass particles must be abutting, or closely adjacent, such that upon heating the particles can be sintered together. Alternatively, the binder can become incorporated into the glass article as a result of pyrolysis of the binder. Such pyrolysis may result in a chemical change that produces a binding material interconnecting adjacent glass particles. For example, an organic binder may pyrolize and form silicon carbide with the glass particles in such a way that a plurality of glass particles are connected in the finished glass article by silicon carbide bonds. Additionally, other binding mechanisms may also bind the glass particles together.

The particle binder can be mixed with glass particles in ratios of from 2:1 to 10:1 (glass to particle binder ratio, by weight), depending on the desired properties of the resulting porous glass object and the adhesive properties of the particle binder.

In certain embodiments, the particle binder comprises one or more of the following substances: i.) polysaccharides such as starches, glycogen, arabinoxylans, cellulose, chitin, pectins, acidic polysaccharides, or bacterial polysaccharides; ii.) oligosaccharides such as fructo- and mannan-oligosaccharides; iii.) disaccharides such as sucrose; iv.) monosaccharides such as glucose, fructose, and xylose; v.) glutens; vi.) plasters such as gypsum- or lime-based; vii.) minerals such as kaolinite; viii.) natural or synthetic polymers such as cyanoacrylate.

The glass particles and particle binder can be mixed in either wet or dry conditions.

The addition of a liquid (i.e., in a “wet” precursor) will enable the mixture to be used in manufacturing processes such as pressing, casting, and extruding.

In one embodiment, the liquid is added to the mixture with ratios of 2:1 to 10:1 (mixture to liquid ratio, by weight), depending on the desired viscosity of the mixture. For example, the less liquid in the mixture, the higher the viscosity.

The liquid in the wet precursor can be any liquid that will both solvate the binder and form a homogenous slurry when mixed with the glass particles, such that the binder-loaded liquid contacts and coats the glass particles to form the wet precursor.

In one embodiment, the liquid comprises one or more of water and a lower-alkyl alcohol (e.g., ethanol or methanol); wherein the liquid has a boiling point of less than 525° K. It will be appreciated that there are many other liquids that are compatible with the disclosed methods. One of skill in the art is capable of selecting an appropriate liquid based on the surface polarity of the glass particles (i.e. the liquid should have a similar polarity) and the binder used (i.e., the liquid should solvate the binder).

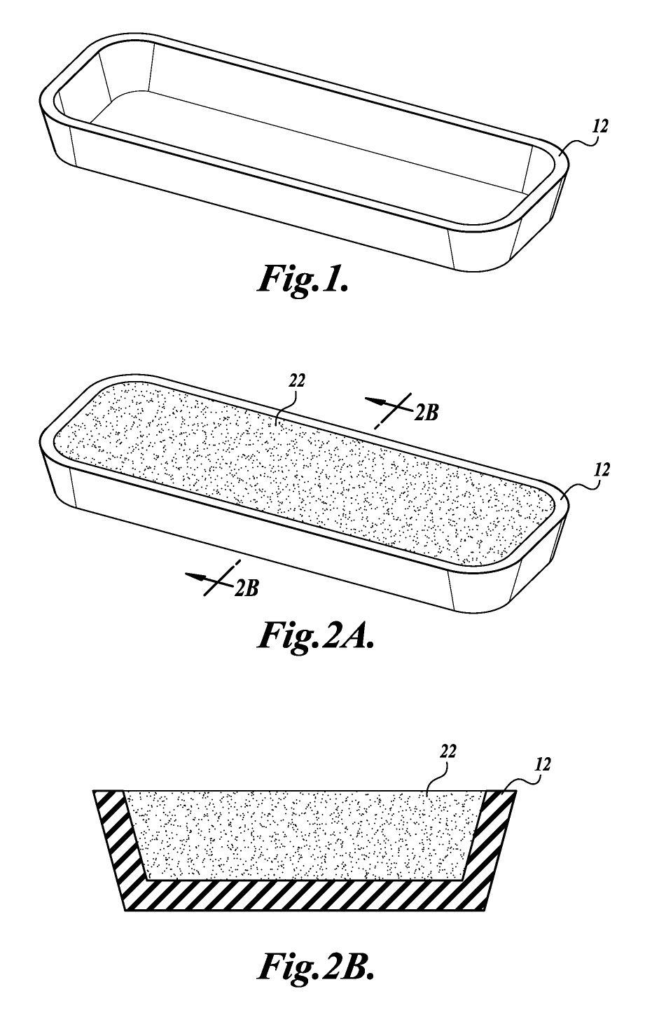

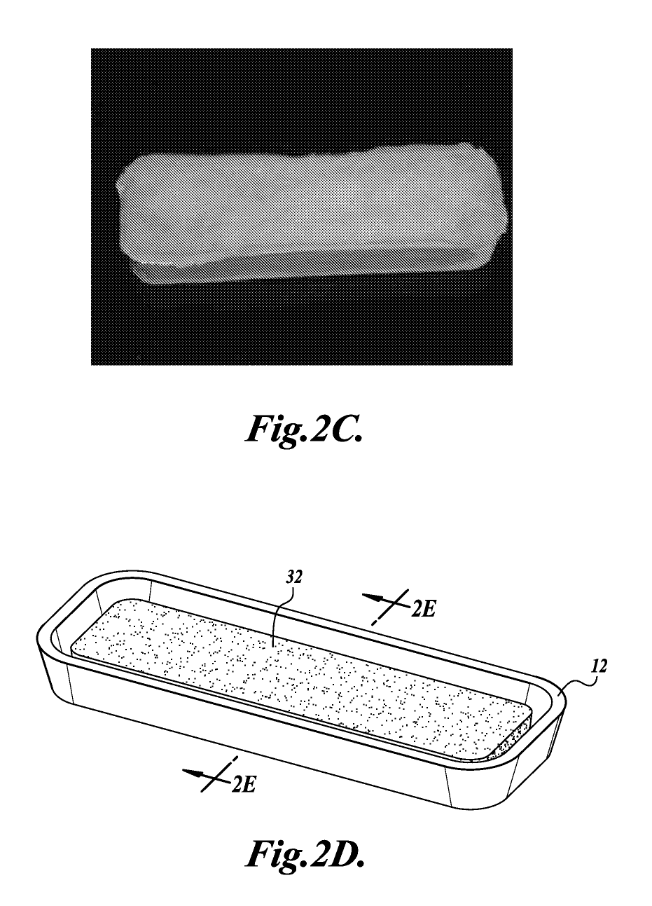

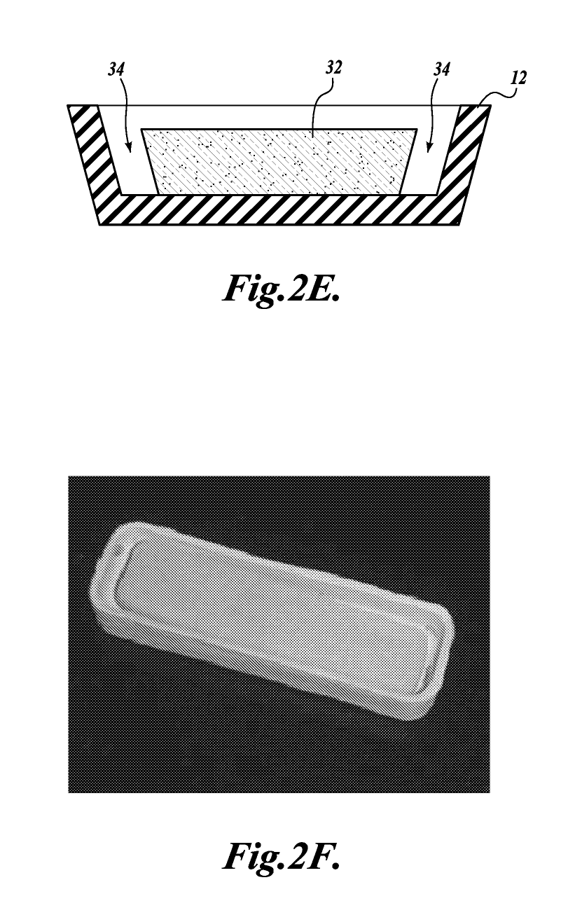

Referring to FIGS. 1-2F, an exemplary method for forming an article in accordance with the embodiments provided herein will now be described. Referring to FIG. 1, a mold 12 capable of withstanding the temperatures required to produce the glass article from the precursor. Such high-temperature molds are well known to those of skill in the art and include metal and ceramic molds, for example.

Referring to FIG. 2A, a precursor 22 is filled into the mold 12. A cross-sectional view is illustrated in FIG. 2B. The precursor can be a wet (glass particles, liquid, and binder) or dry (glass particles and optional binder) precursor. If the precursor 22 is a dry precursor, the mold 12 is vibrated so as to pack the precursor 22 within the mold 12 such that the glass particles within the precursor 22 are packed as tightly as possible prior to heating. If the precursor 22 is a wet precursor, the wet precursor in slurry form can be pored, scooped, or otherwise deposited into the mold 12. Prior to heating, the wet precursor 22 is allowed to dry until most or all of the liquid in the wet precursor is evaporated. Drying prevents potential damage to the glass article during heating, which may be brought about by uncontrolled gas expansion during liquid evaporation.

FIG. 2C is a photograph of an exemplary wet precursor in a mold prior to heating to form a glass article. The exemplary embodiment pictured in FIG. 2C was formed as follows: A slip-casted ceramic mold was prepared to form the wet precursor. The wet precursor included a mixture of 30 parts glass particles (ranging in size from 1 nm to 500 microns), 3 parts disaccharides (sucrose), 3 parts polysaccharides (maltodextrin), and 10 parts water. The wet precursor was poured into the mold and allowed to dry for one day at room temperature in an air atmosphere.

Referring to FIGS. 2D and 2E, after the precursor 22 is heated according to a heating schedule, a glass article 32 is formed. As illustrated in FIG. 2D and the cross-sectional view in FIG. 2E, the formed glass article 32 is of smaller dimension than the precursor 22 in the mold 12 prior to heating. The reduction in size after heating results from a higher density of glass in the glass article 32 compared to the precursor 22.

The density of the glass article 32 can be controlled by controlling the composition of the precursor 22 as well as the heating profile. Accordingly, the shrinkage between the precursor 22 and the glass article 32 can be controlled.

As illustrated in FIG. 2E, the shrinkage during heating results in gaps 34 forming between the mold 12 and the glass article 32. Additionally, the glass article 32 has a lower profile in the mold 12 than did the precursor 22.

A picture of a glass article formed by heating the precursor pictured in FIG. 2C, is pictured in FIG. 2F. The glass article was formed after drying the precursor illustrated in FIG. 2C for one day. Next, the dried precursor in the mold was placed into a kiln/furnace. The precursor was subjected to the following heating schedule: 1) 100° F./hr ramp rate, 2) hold for 1 hour at 300° F., 3) 200° F./hr ramp rate, 4) hold for 30 minutes at 1300° F., 5) cool to room temperature.

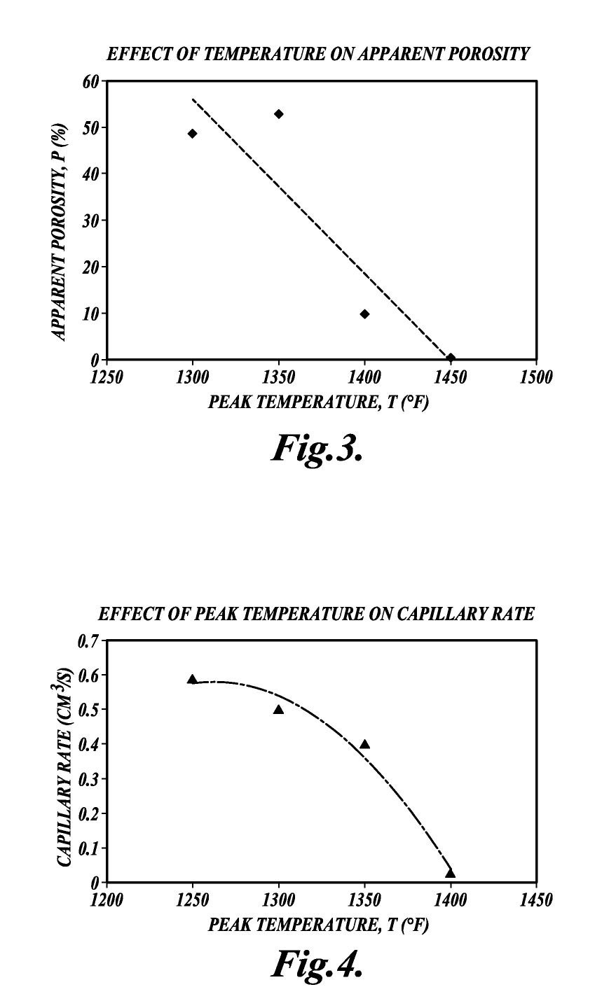

FIGS. 3-6 show the effects of peak firing temperatures on the finished glass article. The mixture and heating schedule was similar to that described above with reference to FIGS. 2C and 2F, however, the peak firing temperature in part 4) was varied to determine the effect of peak temperature on the various properties.

Exemplary glass articles formed using the wet precursor method were characterized according to apparent porosity, capillary rate for moving water and the time required to reach certain degrees of saturation of water. First, FIG. 3 illustrates the effect of peak heating temperature on apparent porosity, as measured in accordance with ASTM guidelines described elsewhere herein. As illustrated in FIG. 3, the higher the peak temperature used when forming a glass article, the lower apparent porosity of the glass article.

As a result of the lower apparent porosity of glass articles formed using a higher peak temperature, the capillary rate for moving water through the formed glass article is lower when the glass article is formed using a higher peak temperature. That is, a higher apparent porosity of the glass article will result in a higher capillary rate.

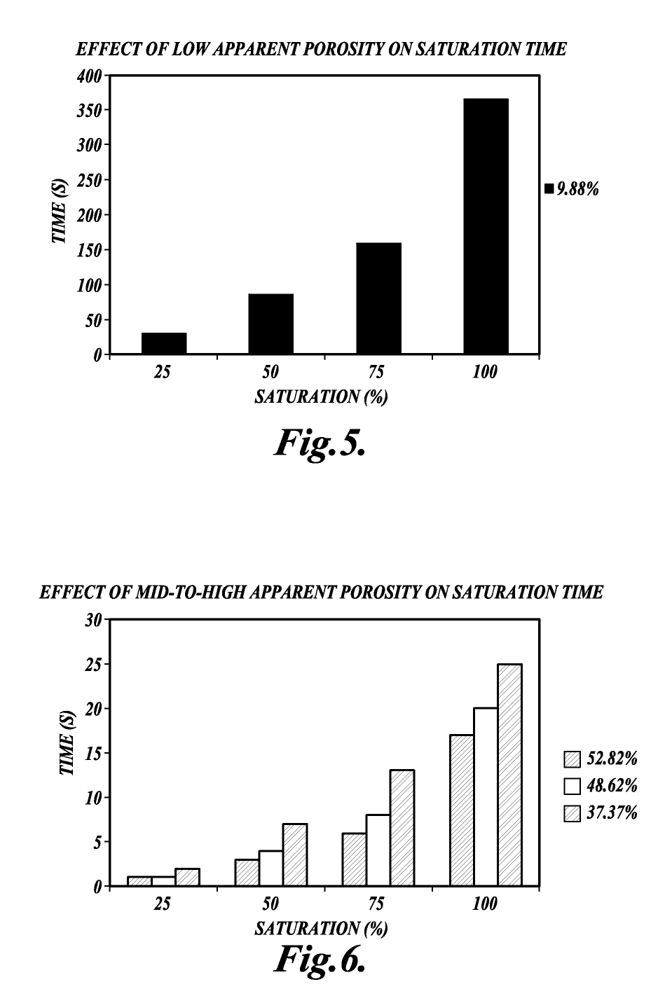

The glass articles will saturate with a liquid that is brought into contact with the glass article, assuming sufficient liquid is present to fill the volume of the porous interconnected network. The time required to reach full saturation depends on the characteristics of the glass article, such as apparent porosity and composition, as well as the viscosity and other characteristics of the liquid. FIGS. 5 and 6 illustrate the relationship between apparent porosity and saturation time. The saturation time is measured as the amount of time required to reach 25%, 50%, 75%, and 100% saturation of the glass article. FIG. 5 illustrates data obtained using a glass article having 9.88% apparent porosity, which results in a time of about 6 minutes to reach 100% saturation. As the apparent porosity of the glass article increases (37.37%, 48.62%, and 52.82%), as illustrated in FIG. 6, the time required to saturate the glass article to 100% is reduced by about an order of magnitude.

While not wishing to be bound by theory, there are several mechanisms by which the glass particles of the precursor bind together to form the glass article.

If no binder is present, the glass particles abutting with other glass particles will be sintered together based on localized heating at the contact point between two particles.

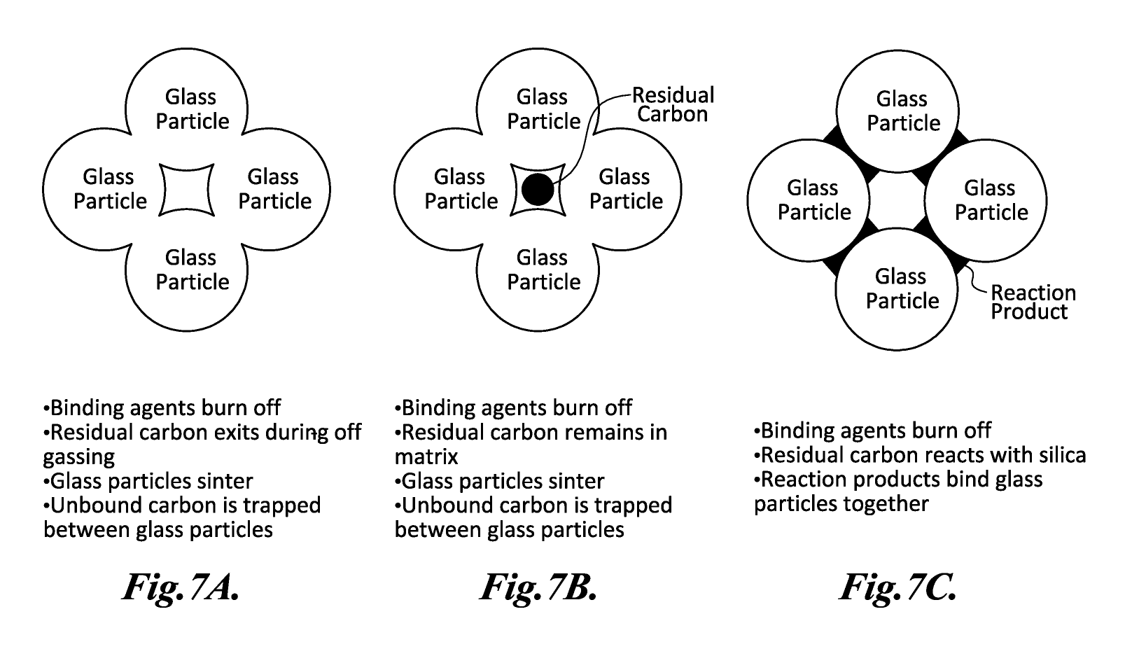

Referring to FIG. 7A, if a binder (“binding agent”) is used, the binder may burn off during heating as a result of the inherent properties of the binder, e.g., if the maximum heating temperature is greater than the boiling or decomposition temperature of the binder. If the binder is an organic material, residual carbon from the material will exit as offgassing and the glass particles will sinter based on localized heating. Unbound organic binder material may be trapped between formed glass particles, as well.

In the embodiment illustrated in FIG. 7B, residual carbon from the binder is retained in the glass article as trapped pyrolyzed carbon.

Referring to FIG. 7C, yet another embodiment of the glass article is illustrated that provides a potential structure for a glass article formed using a binder. In the embodiment illustrated in FIG. 7C, the binder is partially eliminated during heating, but residual carbon from the binder reacts with silica of the glass particles to form a reaction product, such as silicon carbide, which forms a chemical bond between the glass particles. In addition to being bound by the reaction product, the glass particles may also be sintered together, or a combination of sintering and binding through reaction products may occur.

It will be appreciated that in certain embodiments, only the mechanism illustrated in FIG. 7A occurs. In other embodiments, only the mechanism of FIG. 7B occurs. In yet other embodiments, only the mechanism illustrated in FIG. 7C occurs. It will also be appreciated that in certain embodiments, two or more of the mechanisms illustrated in FIGS. 7A-7C occur when forming the glass article.

Methods for Making the Glass Article

In one aspect, a method is provided for forming a glass article comprising a porous interconnected network of fused glass particles that has an apparent porosity, as described herein. Each heating schedule is formulated to produce the desired pore morphology within the glass article after heating, thereby controlling capillary forces. In addition, each precursor mixture is formulated in order to produce the desired viscosity, malleability, formability, and casting properties (e.g., so extrusion is possible).

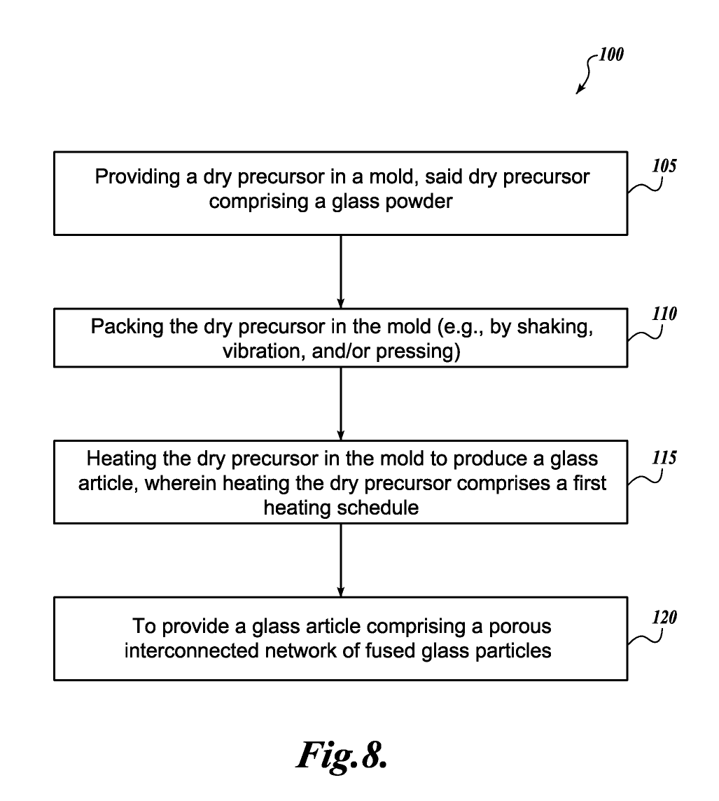

In one embodiment, as illustrated in FIG. 8, a method 100 is provided having the following steps.

In a first step 105, a dry precursor is provided in a mold. In one embodiment, the dry precursor comprises a glass powder having a particle size of from 0.001 to 2200 microns. A binder can optionally be added to the precursor. The dry precursor is described elsewhere herein.

The method 100 continues with a second step 110 of packing the dry precursor in the mold. The dry precursor is packed so as to provide the maximum possible contact between the glass particles and the glass powder so as to facilitate sintering or binding between the particles during heating to form the glass article. Exemplary methods for packing the dry precursor include shaking, vibration, and pressing. It will be appreciated that other packing techniques known to those of skill in the art are also useful in the methods provided herein.

The method 100 continues with a third step 115 of heating the dry precursor in the mold to produce a glass article. Heating the dry precursor comprises a first heating schedule that includes at least the steps of heating to a first temperature, heating to a second temperature that is greater than the first temperature, and cooling to a third temperature that is less than the first temperature. As will be described further below, in certain embodiments, a fourth step of the heating profile is included, which comprises a fourth temperature that is less than the third temperature. The temperatures of the heating profile, the ramp rates between the temperatures, and the times that the temperatures are held (“hold times”), all affect the properties (e.g., apparent porosity, strength, and density) of the formed glass article.

The heating profile applied to the precursor in this and other aspects disclosed herein is typically delivered by a kiln or other type of furnace known to those of skill in the art. It will be appreciated that any heating method capable of applying the necessary temperatures and ramp rates will be useful with the provided methods.

The method 100 concludes with a step 120 of providing the glass article, which can be removed from the mold after cooling from the heating schedule of step 115.

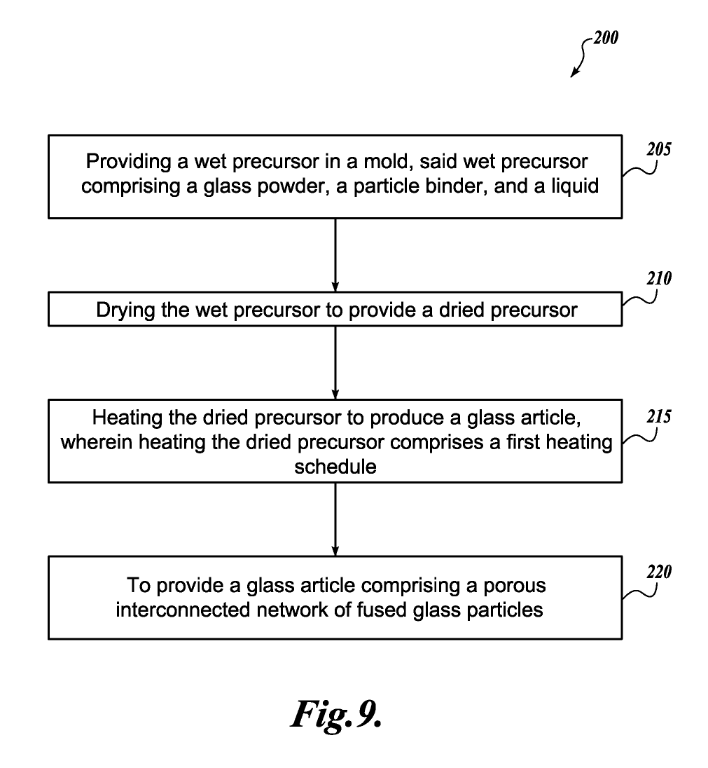

In another aspect, a “wet” method is provided for forming a glass article comprising a porous interconnected network of fused glass particles, as illustrated in FIG. 9. The method 200 is similar to the dry method 100 illustrated in FIG. 8.

Referring now to FIG. 9, the method 200 begins with a step 205 that includes providing a wet precursor in a mold. In one embodiment, the wet precursor includes a glass powder, a particle binder, and a liquid. The method 200 is considered a wet method because a liquid is included in the precursor. The liquid allows the precursor to be extruded, formed by hand, formed without a mold, or formed with a mold, so as to provide great versatility in the methods by which the precursor can be shaped prior to heating, and therefore, great versatility is provided with regard to the shape of the formed glass article.

The method 200 continues with a step 210 of drying a wet precursor to provide a dried precursor. In step 210, the drying occurs over a course of minutes, hours, or days, depending on the nature of the liquid. The drying step may or may not require heating depending on the nature of the liquid (e.g., boiling point) and the forming process being used, and lasts in duration until the liquid is substantially eliminated from the precursor.

The method 200 continues with a step 215 of heating the dried precursor to produce a glass article. As with the method 100 of FIG. 8, the heating step 215 includes heating using a first heating schedule.

The method 200 concludes with a step 220 of providing the formed glass article after heating that includes a porous interconnected network of fused glass particles.

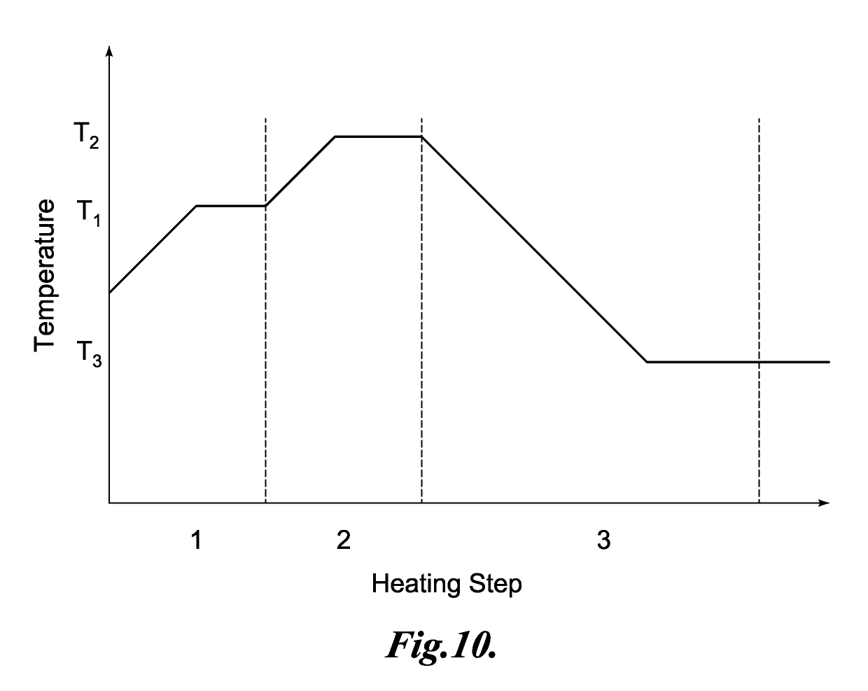

As described above, the methods provided herein include the use of a heating schedule. Two primary heating schedules are disclosed herein, a three-step schedule and a four-step schedule. Referring to FIG. 10, a three-step heating schedule is provided wherein the first step includes a temperature ramp at a first ramp rate to a first temperature (T₁), which is held for a first hold time. After the first hold time, the heating schedule proceeds to heating step two, which includes a ramp at a second ramp rate from the first temperature to a second temperature (T₂), which is held for a second hold time. The method concludes with a third step that includes a decreasing third ramp at a third ramp rate to a third temperature (T₃) that is lower than the first temperature. The third temperature is held for a third hold time. After the third hold time, the glass article is formed and can be further cooled to room temperature and removed from the mold.

Table 1 provides exemplary ranges for the various heating schedule events in a three-step schedule for various precursor types and mold types.

TABLE 1
Three-Step Heating Schedules.

| Heating Schedule | Dry Precursor | Dry Precursor | |
|---|---|---|---|
| Event | Metal Mold | Non-Metal Mold | Wet Precursor |
| First Ramp (° F./hour) | 25-1500 | 25-500 | 10-500 |
| First Temp (° F.) | 100-700 | 100-700 | 50-700 |
| First Hold (min.) | 5-200 | 5-200 | 5-200 |
| Second Ramp (° F./hour) | 25-1500 | 25-500 | 10-750 |
| Second Temp (° F.) | 600-1500 | 600-1500 | 600-1500 |
| Second Hold (min.) | 5-500 | 5-500 | 5-500 |
| Third Ramp (° F./hour) | 25-1500 | 25-1500 | 25-1500 |
| Third Temp (° F.) | 300-1100 | 300-1100 | 300-1100 |
| Third Hold (min.) | 5-500 | 5-500 | 5-500 |

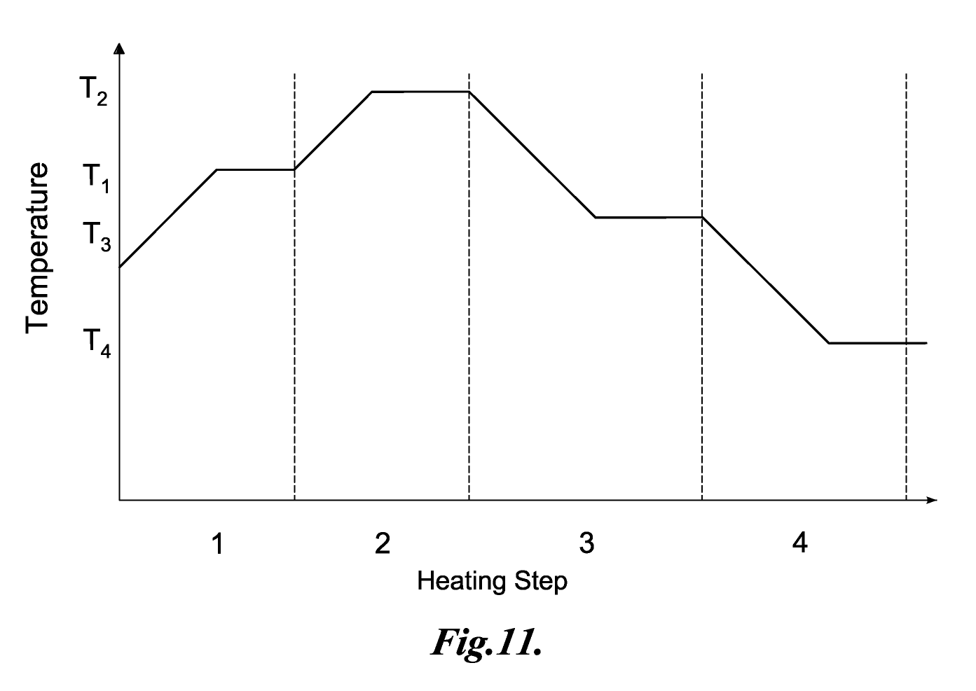

Referring to FIG. 11, a four-step heating schedule is illustrated that is similar to that illustrated in FIG. 10, although a fourth heating step is included whereby a fourth ramp rate reduces the temperature from the third temperature (T₃) to a fourth temperature (T₄). The fourth temperature is then held for a fourth hold time, after which the glass article is formed.

The four-step heating scheduling illustrated in FIG. 11 is particularly useful to control the characteristics of the formed glass article. In particular, by including the third and fourth heating steps, which gradually reduce the temperature of the forming glass article from the maximum heating temperature (T₂), it has been determined that the quality of the formed glass article is improved. The four-step method yields a higher quality glass article that is more uniform in apparent porosity across the entire glass article, compared to a similar article formed using the three-step method.

Particularly, the quality of the formed glass article will be improved if a slower cooling rate is used in the third heating step than in the fourth heating step. In this regard, in exemplary embodiments of the method, the heating steps are provided using convective heat transfer, which is defined as heat energy transferred between a surface and a moving fluid (e.g., air within a furnace, at different temperatures).

Table 2 provides exemplary ranges for the various heating schedule events in a four-step schedule for various precursor types and mold types.

TABLE 2
Four-Step Heating Schedules.

| Heating Schedule | Dry Precursor | Dry Precursor | |
|---|---|---|---|
| Event | Metal Mold | Non-Metal Mold | Wet Precursor |
| First Ramp (° F./hour) | 25-1500 | 25-500 | 10-500 |
| First Temp (° F.) | 100-700 | 100-700 | 50-700 |
| First Hold (min.) | 5-200 | 5-200 | 5-200 |
| Second Ramp | 25-1500 | 25-500 | 10-750 |
| (° F./hour) | | | |
| Second Temp (° F.) | 600-1500 | 600-1500 | 600-1500 |
| Second Hold (min.) | 5-500 | 5-500 | 5-500 |
| Third Ramp (° F./hour) | 25-1500 | 25-1500 | 25-1500 |
| Third Temp (° F.) | 300-1100 | 300-1100 | 300-1100 |
| Third Hold (min.) | 5-500 | 5-500 | 5-500 |
| Fourth Ramp | 25-1500 | 25-1500 | 25-1500 |
| (° F./hour) | | | |
| Fourth Temp (° F.) | 50-600 | 50-600 | 50-600 |
| Fourth Hold (min.) | 5-500 | 5-500 | 5-500 |

In an exemplary embodiment, the third heating step (reducing the temperature of the forming glass article from T₂ to T₃) is performed using “free” or “natural” convection. That is, the third ramp rate is provided by natural convection. Natural convection is caused by buoyancy forces due to density differences caused by temperature variations in a fluid (e.g., air). At heating, the density changes in the boundary layer will cause the fluid to rise and be replaced by cooler fluid that also will heat and rise. The continual phenomenon of such a convection mechanism is defined as free or natural convection. Essentially, natural convection results, for example, when a heat source is removed (e.g., a heating element turned off) and the kiln/article cools according to interaction between the warm air inside the kiln and the cooler air outside the kiln.

In certain embodiments, the fourth heating step occurs using forced convection, as opposed to natural convection. That is, the fourth ramp rate is provided by forced convection. Forced convection occurs when a fluid flow is induced by an external force, such as a pump, fan, or mixer. Forced convection is almost always a faster cooling process than natural convection. Accordingly, in one embodiment, the third heating step is performed using natural convection and the fourth heating step is performed using forced convection.

The characteristics of the heating schedule are selected based on the desired properties of the glass article formed. Accordingly, a broad range of possible values for the ramp rates, target temperatures, and hold times, for the various heating steps described with regard to FIGS. 10 and 11, are possible. Additionally, the heating schedule will change if using a dry precursor or a wet precursor.

For example, in certain embodiments, a four-step heating schedule is used. The heating schedule is used for a dry precursor. The first ramp rate is from 850 to 1150° F. per hour to a first temperature (T₁) of from 850 to 1150° F. The first temperature is held for between 15 and 25 minutes. The heating schedule proceeds with a second ramp at a rate of from 255 to 345° F. per hour to a second temperature (T₂) of from 1100 to 1500° F. The second temperature is held for between 15 and 25 minutes. Natural cooling at a rate of 25 to 250° F./hour, is then used to reduce the temperature from T₂ to a third temperature (T₃) that is from between 595 to 805° F. with a hold time of 5 to 500 minutes. The heating schedule concludes with forced cooling at a rate of 250 to 1500° F./hour to a fourth temperature (T₄) that is from 170 to 230° F. with a hold time of 5 to 500 minutes.

The above heating schedule is useful if using a metal mold for a dry precursor. The heating schedule would be modified (e.g., a lower first ramp rate) if a slip casted mold or refractory mold is used. For example, the first ramp rate for a slip casted mold would be modified to be from 425 to 575° F. per hour.

Additionally, if a wet precursor is used, the heating schedule will be different than for a dry precursor. For example, in certain embodiments, the following heating schedule is used for a wet precursor. The first ramp rate is from 255 to 345° F. per hour to a first temperature (T₁) of from 935 to 1265° F. The first temperature is held for between 15 and 25 minutes. The heating schedule proceeds with a second ramp at a rate of from 170 to 230° F. per hour to a second temperature (T₂) of from 1100 to 1500° F. The second temperature is held for between 10 and 30 minutes. Natural cooling is then used to reduce the temperature from T₂ to a third temperature (T₃) that is from between 595 to 805° F. The heating schedule concludes with forced cooling to a fourth temperature (T₄) that is from 170 to 230° F.

For the above wet and dry precursor heating schedules, if a higher or lower porosity is desired, the second temperature (T₂) or the time at which T₂ is held, can be decreased or increased, respectively. The effect of peak firing temperature on apparent porosity is shown in FIGS. 3 and 4.

In certain embodiments, the glass article is configured for use as a building material. Representative building materials include both structural and non-structural materials. Representative structural materials include load-bearing articles configured to replace masonry. For example, bricks or panels. Representative non-structural materials include facades, landscaping elements, cladding, slip-free oil collectors (e.g., for use in a garage), pavers, countertops, tiles, and fountains.

Living Systems

In certain embodiments, the glass article is configured for use a medium for supporting and/or hydrating vegetation. Such an application is referred to herein as a “living” system. In certain embodiments, the living article is configured for a use selected from the group consisting of an architectural use, a horticultural use, an agricultural use, and combinations thereof. In certain embodiments, the living article is incorporated into a roof or wall. In certain embodiments, the article is incorporated into a hydroponic or aeroponic wall or a hydroponic or aeroponic roof.

A living or green roof is a roof that has been designed to sustain plant life for architectural, aesthetic, artistic, horticultural, botanical, or agricultural purposes. A living or green wall is a wall that has been designed to sustain plant life for architectural, aesthetic, artistic, horticultural, botanical, or agricultural purposes. Hydroponics is defined as the growing of plants in nutrient solutions with or without an inert medium, such as soil, to provide support. Aeroponic is defined as a technique for growing plants in air or in a mist without the use of soil, aggregate, or a hydroponic medium.

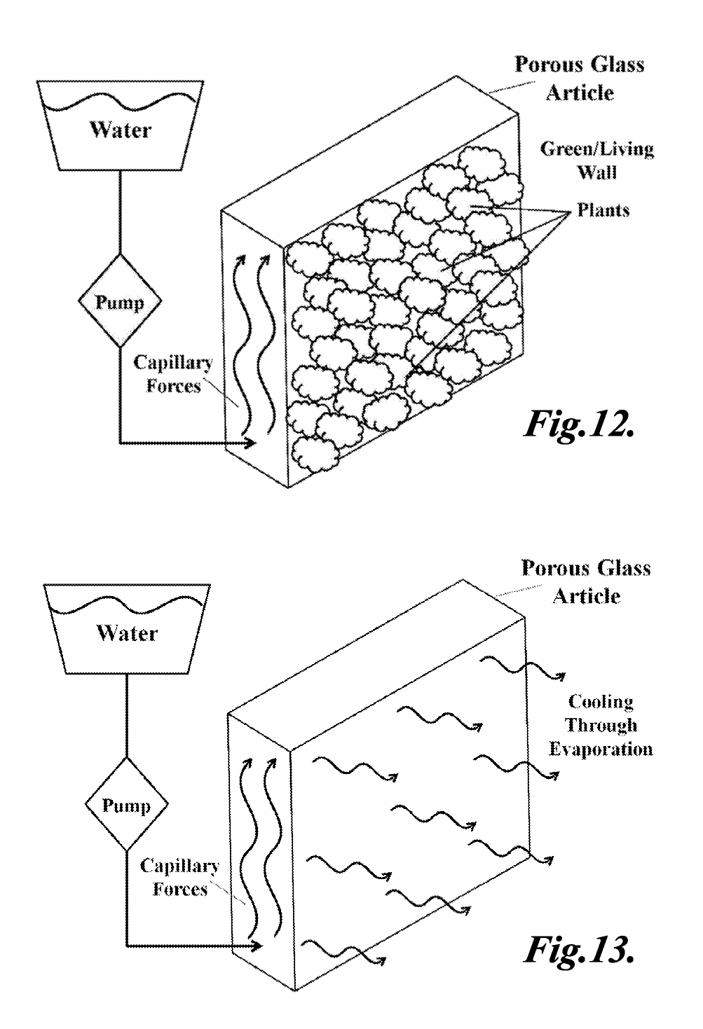

A living wall (or roof, etc.) comprising the glass article also includes one or more of plumbing, a pump, a water source, a nutrition source, and plant life. Referring now to FIG. 12, a diagrammatic illustration of a living wall is provided. The living wall integrates a porous glass article that is formed so as to have recesses, holes, or other receptacles for rooting plants. Alternatively, the porous glass article may be produced with a macro-scale textured surface acceptable for vegetation with adhering roots, such as mosses, ivy, vines, and other clinging plants. Water is pumped or otherwise into contact with the porous glass article and the capillary forces within the porous glass article transfer the water throughout the porous glass article until saturation is reached. Once saturated, the glass article provides moisture to the plants within or located on the article so as to allow the plants to live and grow. Through engineering, the living wall allows a structural or aesthetic wall to be formed that can also grow plant life.

In one embodiment of a living system, the glass article can act as a growing medium or a hydrating medium for rock wool plugs, moss, or other hydroponic mediums that sustain plant life. In another embodiment, the glass article can be mounted to a structure (vertically or horizontally) or mounted directly on a roof. In yet another embodiment, plants can grow directly on the glass article.

In one embodiment, the glass article is formed into a capillary plate. A capillary plate can be used under a substrate such as mulch, soil, or moss to provide sub-irrigation, water retention, and filtration.

The glass articles can also be used to form capillary aggregates, which are spherical, other geometrical shapes, non-geometrical shapes, and combinations thereof, that provide irrigation, water retention, and filtration.

In one embodiment, the glass articles are used as a plant-growing substrate where plants can be started from seed directly on the article using a sub-irrigating method.

In one embodiment, the glass articles can be used as capillary pots, which provide water retention for plants, soil, moss, or mulch through sub-irrigation.

Evaporative Cooling

In certain embodiments, the glass article is incorporated into an evaporative cooling system. In addition to the glass article, an evaporative cooling system includes one or more of plumbing, a pump, a water source. Referring to FIG. 13, a diagrammatic illustration of an embodiment of an evaporative cooling system is provided. In an evaporative cooling system, a porous glass article as provided herein is saturated with water using capillary forces and as the water evaporates from the glass article, cooling occurs according to the laws of thermodynamics. By integrating an evaporative cooling wall into a building or other structure, cooling using only the evaporation of water can be effected, which is both environmentally friendly and energy efficient.

Evaporative cooling systems incorporating the glass articles are useful whenever cooling is required. However, certain uses for such systems are particularly desirable. For example, in one embodiment, the cooling system is used for cooling a power plant. In this regard, the glass article can be used in the cooling towers in such a way that glass article, in plate or brick form, is saturated with water to provide cooling through evaporation.

In other application of the cooling system, the significant heat generated by commercial, industrial, institutional, hospital, and residential buildings can be remedied by providing glass articles in the areas in need of cooling and saturating the articles with water. When the water in the articles evaporates, ambient cooling results. For example, the significant heat generated by electronics in a data center can be alleviated by using glass bricks or plates attached to a source of water.

Evaporative cooling is a highly efficient means of cooling, which makes use of the large quantity of energy required for a material to undergo a liquid-to-vapor phase change. The thermal energy expended during this evaporation process is proportional to the cooling effect. The system itself requires only enough energy to provide moisture to the porous glass article (i.e. through pumping or spraying), whereas traditional air conditioning units require large quantities of electricity. As such, the energy savings are quite large when compared to these conventional methods. Additional benefits include stormwater management and decreased overall greenhouse gas emissions associated with the cooling of a space.

Glass Recycling

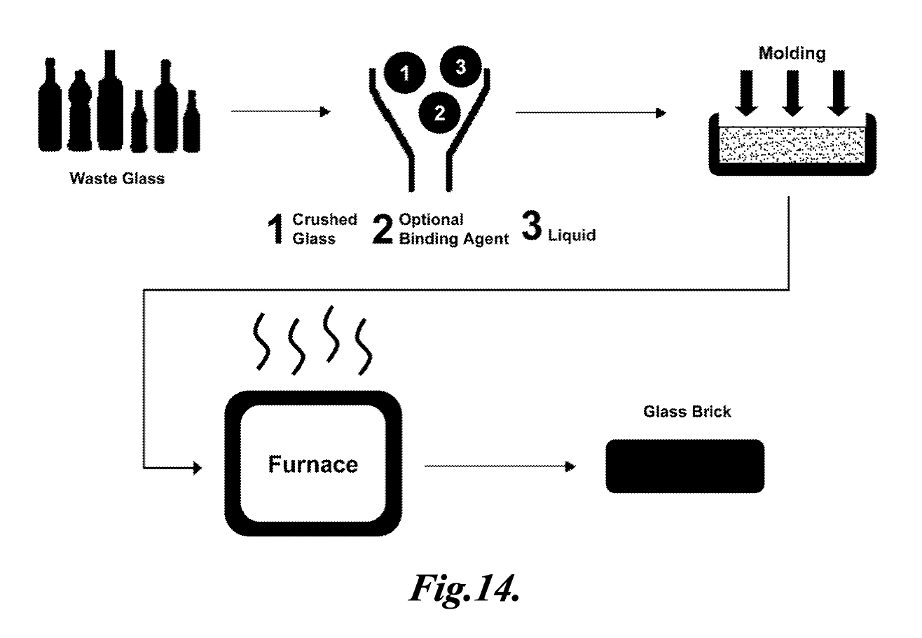

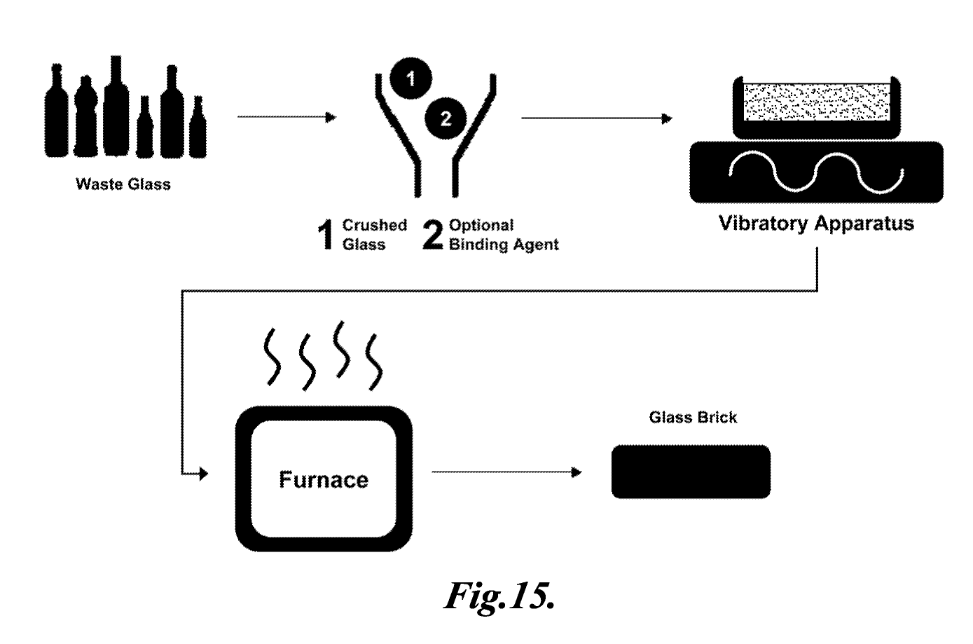

In certain embodiments, the glass articles can be formed using recycled waste glass, such as post-consumer and post-industrial waste glass. The methods provided herein are particularly useful because the glass articles can be formed using a relatively high contaminant content, which would likely be present in a recycled glass source. Referring to FIGS. 14 (wet precursor) and 15 (dry precursor), flow diagrams are provided that illustrate the progress of forming a glass brick (e.g., glass article) from waste glass. Referring to FIG. 14, waste glass is pulverized and ground into micron-sized particles where it is then combined with a liquid to form a slurry and an optional binder. The precursor is then molded, heated according to a heating schedule, and a glass brick is produced. Referring to FIG. 15, in the dry process, glass is pulverized and an optional binder is added. The precursor is then placed into a mold and vibrated or otherwise packed. The packed molded precursor is then heated according to a heating schedule to produce a glass brick.

While illustrative embodiments have been illustrated and described, it will be appreciated that various changes can be made therein without departing from the spirit and scope of the invention.

1. A method for forming a glass article comprising a porous interconnected network of fused glass particles that has an apparent porosity of 1-55%, the method comprising the steps of:
(a) providing a dry precursor in a mold, said dry precursor comprising a glass powder having a particle size of from 0.001-2200 microns;
(b) packing the dry precursor in the mold; and
(c) heating the dry precursor in the mold to produce a glass article, wherein heating the dry precursor comprises a first heating schedule that includes at least the sequential steps of:
(i) heating at a first rate to a first temperature and holding for a first hold time;
(ii) heating at a second rate to a second temperature and holding for a second hold time, wherein the second temperature is greater than the first temperature;
(iii) cooling by convection at a third rate to a third temperature and holding for a third hold time, wherein the third temperature is less than the first temperature; and
(iv) cooling by convection at a fourth rate to a fourth temperature and holding for a fourth hold time, wherein the fourth temperature is less than the third temperature.

2. The method of claim 1, wherein the first temperature is 1150° F. or less, the second temperature is 1495° F. or less, the third temperature is 805° F. or less, and the fourth temperature is 230° F. or less.

3. The method of claim 1, wherein the dry precursor comprises a particle binder selected from the group consisting of a polysaccharide, an oligosaccharide, a disaccharide, a monosaccharide, a gluten, a plaster, a mineral, a polymer, and combinations thereof.

4. The method of claim 3, wherein the particle binder is capable of adhering to the glass powder.

5. The method of claim 3, wherein the particle binder is eliminated during the first heating schedule to create a pore in the porous interconnected network of the formed glass article.

6. The method of claim 3, wherein the ratio of the glass powder to the particle binder is from 2:1 to 10:1 by weight.

7. A method for forming a glass article comprising a porous interconnected network of fused glass particles that has an apparent porosity of 1-55%, the method comprising the steps of:
(a) providing a wet precursor in a mold, said wet precursor comprising a glass powder having a particle size of from 0.001-2200 microns, a particle binder, and a liquid;
(b) drying the wet precursor to provide a dried precursor; and
(c) heating the dried precursor to produce a glass article, wherein heating the dried precursor comprises a first heating schedule that includes at least the sequential steps of:
(i) heating at a first rate to a first temperature and holding for a first hold time;
(ii) heating at a second rate to a second temperature and holding for a second hold time, wherein the second temperature is greater than the first temperature;
(iii) cooling by convection at a third rate to a third temperature and holding for a third hold time, wherein the third temperature is less than the first temperature; and
(iv) cooling by convection at a fourth rate to a fourth temperature and holding for a fourth hold time, wherein the fourth temperature is less than the third temperature.

8. The method of claim 7, wherein the first temperature is 1265° F. or less, the second temperature is 1495° F. or less, the third temperature is 805° F. or less, and the fourth temperature is 230° F. or less.

9. The method of claim 7, wherein the particle binder is capable of adhering to the glass powder.

10. The method of claim 7, wherein the particle binder is eliminated during the first heating schedule to create a pore in the porous interconnected network of the formed glass article.

11. The method of claim 7, wherein the ratio of the glass powder to the particle binder is from 2:1 to 10:1 by weight.

12. The method of claim 7, wherein the particle binder is selected from the group consisting of a polysaccharide, an oligosaccharide, a disaccharide, a monosaccharide, a gluten, a plaster, a mineral, a polymer, and combinations thereof.

13. The method of claim 7, wherein the glass powder and the particle binder define a dry precursor mixture, and wherein the ratio of the dry precursor mixture to the liquid is from 2:1 to 10:1 by weight.

14. The method of claim 7, wherein the liquid is selected from the group consisting of water and a lower-alkyl alcohol; wherein the liquid has a boiling point of less than 525° K.

15. The method of claim 7, wherein providing the wet precursor in a mold comprises a method selected from the group consisting of pressing, casting, and extrusion.

16. A glass article comprising a porous interconnected network of fused glass particles that has an apparent porosity of 1-55% and the ability to deliver water throughout the glass article via capillary forces.

17. The glass article of claim 16, wherein the glass article is configured for use as a building material.

18. The glass article of claim 16, wherein the glass article is configured for a use selected from the group consisting of use as a medium for supporting vegetation, use as a medium for hydrating vegetation, and combinations thereof.

19. The glass article of claim 18, wherein the glass article is configured for a use selected from the group consisting of an architectural use, a horticultural use, an agricultural use, and combinations thereof.

20. The glass article of claim 18, wherein the glass article is selected from the group consisting of a living roof, a green roof, a living wall, a green wall, a hydroponic or aeroponic wall, a hydroponic or aeroponic roof, and combinations thereof.

21. The glass article of claim 18, wherein the glass article is configured to for use in a system comprising one or more of plumbing, a pump, a water source, a nutrition source, plant life.

22. The glass article of claim 16, wherein the glass article is configured for use in an evaporative cooling system.

23. The glass article of claim 22, wherein the evaporative cooling system comprises one or more of plumbing, a pump, a water source; wherein the glass article is uses as an evaporative cooling medium configured to evaporate water.

24. The glass article of claim 16, wherein the glass article has a contamination ratio of 9:1 or less, wherein the contamination ratio is the ratio of a weight of fused glass particles to a weight of one or more contaminants.

25. The glass article of claim 24, wherein the contaminants are selected from the group consisting of paper, plastic, ceramic, metal, and combinations thereof.

26. A method for forming a glass article comprising a porous interconnected network of fused glass particles that has an apparent porosity of 1-55%, the method comprising the steps of:
(a) providing a dry precursor in a mold, said dry precursor comprising a glass powder having a particle size of from 0.001-2200 microns;
(b) packing the dry precursor in the mold; and
(c) heating the dry precursor in the mold to produce a glass article, wherein heating the dry precursor comprises a first heating schedule that includes at least the sequential steps of:
(i) heating at a first rate to a first temperature and holding for a first hold time;
(ii) heating at a second rate to a second temperature and holding for a second hold time, wherein the second temperature is greater than the first temperature; and
(iii) cooling by convection at a third rate to a third temperature and holding for a third hold time, wherein the third temperature is less than the first temperature.

27. A method for forming a glass article comprising a porous interconnected network of fused glass particles that has an apparent porosity of 1-55%, the method comprising the steps of:
(a) providing a wet precursor in a mold, said wet precursor comprising a glass powder having a particle size of from 0.001-2200 microns, a particle binder, and a liquid;
(b) drying the wet precursor to provide a dried precursor; and
(c) heating the dried precursor to produce a glass article, wherein heating the dried precursor comprises a first heating schedule that includes at least the sequential steps of:
(i) heating at a first rate to a first temperature and holding for a first hold time;
(ii) heating at a second rate to a second temperature and holding for a second hold time, wherein the second temperature is greater than the first temperature; and
(iii) cooling by convection at a third rate to a third temperature and holding for a third hold time, wherein the third temperature is less than the first temperature.
